(19) United States
(12) Patent Application Publication
(10) Pub. No.: US 2011/0292362 A1
(43) Pub. Date: Dec. 1, 2011

(54) Exposure apparatus

(75) Inventors: Yoshiyuki Enomoto, Itabashi-ku (JP); Hirohide Minakawa, Itabashi-ku (JP)

(73) Assignee: Kabushiki Kaisha TOPCON, Itabashi-ku (JP)

(21) Appl. No.: 13/134,183

(22) Filed: May 31, 2011

(30) Foreign Application Priority Data
Jun. 1, 2010 (JP) 2010-125439

(51) Int. Cl. G03B 27/68

(52) U.S. Cl. 355/52

(57) ABSTRACT

An exposure apparatus which forms a predetermined mask pattern on a target workpiece through exposure by: casting exposure light upon a mask in which the pattern and a mask-side alignment mark are formed, and forming an image of the mask on the target workpiece by projecting the exposure light, which passes the mask, on the target workpiece through a projection lens, includes: an alignment lighting unit configured to cast, as alignment light, light in a wavelength range included in the exposure light onto the mask-side alignment mark of the mask; and an alignment camera unit including an image pickup device for capturing images, and configured to receive the incident alignment light coming from the alignment lighting unit through the mask and the projection lens.

### PRIORITY CLAIM

The present application is based on and claims priority from Japanese Patent Application No. 2010-125439, filed on Jun. 1, 2010, the disclosure of which is hereby incorporated by reference in its entirety.

### BACKGROUND OF THE INVENTION

1. Technical Field

The invention relates to an exposure apparatus used for manufacturing boards such as printed boards and liquid crystal boards.

2. Description of the Related Arts

In various field, photolithography is widely applied in which: an exposure apparatus transfers a predetermined mask pattern by light exposure onto the surface of a target workpiece coated with a photosensitive material such as a photoresist; and then the target workpiece is etched to form a mask pattern on the board. Printed circuit boards, liquid crystal boards and the like are manufactured by use of exposure apparatuses as well (see Japanese Patent Application Publication No. 2006-292902, for example). One type of exposure apparatus uses ultraviolet light as exposure light, projects the ultraviolet light through a mask having a predetermined pattern formed therein to form a light image of the pattern on the target workpiece by use of a projection lens, and thereby forms the predetermined mask pattern on the target workpiece.

Recently, printed circuit boards and the like having a multilayered structure, a higher integration and a finer circuit pattern have been demanded in response to demand for electronic appliances having a faster processing speed, multiple functions and a smaller size. For example, the multilayered structure means a structure in which one pattern is formed on another pattern formed on a board in an overlapped manner. When the two patterns are formed in the overlapped manner, the upper pattern needs to overlap the lower pattern with such a predetermined positional relationship that the two patterns can keep their electrical conduction or insulation relationship in a predetermined position. To this end, the above-mentioned type of exposure apparatus is required to achieve extremely high precision for the positioning, i.e. alignment, of the exposure position of the mask pattern on the target workpiece.

Meanwhile, in the above-mentioned type of exposure apparatus, the aberration correction of the projection lens is made with high precision with respect to the ultraviolet light used for exposure for the purpose of forming the mask pattern on the target workpiece with higher accuracy. On the other hand, the aberration correction thereof is not made with respect to light not used for the light exposure of the target workpiece (hereinafter referred to as “non-exposure light”). For this reason, it is desirable that the exposure apparatus be configured to use as alignment light the ultraviolet light serving as the exposure light; and to align the position of the mask with the target workpiece by casting the alignment light on the target workpiece through the projection lens. However, because the ultraviolet light acts on the target workpiece in the light exposure, the alignment light of the ultraviolet light should not be cast on the target workpiece. Against this background, an off-axis alignment method using the non-exposure light and a TTL (through the lens) alignment method have been devised as methods of making alignment without exposing the target workpiece.

In the off-axis alignment method, in addition to the projection lens, an alignment optical system is provided for casting as alignment light the non-exposure light on the target workpiece, and is used to align the position of the mask with the target workpiece.

On the other hand, in the TTL alignment method, the projection lens is designed to support so-called “two-wavelength aberration correction (achromatism)” in which the aberration correction is also made with respect to non-exposure light to be used for the alignment; or the projection lens is provided with a correction optical system capable of correcting the aberration of the projection lens with respect to the non-exposure light. The TTL alignment method aligns the position of the mask with the target workpiece by casting the non-exposure light through the projection lens upon the target workpiece.

Nevertheless, the off-axis alignment method has difficulty obtaining extremely high alignment precision, because the alignment is made by use of alignment light which does not pass the projection lens. In addition, the off-axis alignment method entails labor and increased costs, because the alignment optical system needs to be positioned with respect to the projection lens with extremely high precision. Furthermore, it is difficult to completely eliminate error in the positioning of the alignment optical system with respect to the projection lens, and therefore the off-axis alignment method has difficulty obtaining the extremely high alignment precision.

Moreover, the TTL alignment method has difficulty enabling the mask pattern to be formed on the target workpiece with high accuracy while suppressing cost increase, and has difficulty obtaining extremely high alignment precision, because it is very difficult to form a projection lens whose aberration is corrected with respect to the two wavelengths of the exposure light and the non-exposure light to be used for the alignment. Even if the correction optical system capable of correcting the aberration of the projection lens with respect to the non-exposure light is intended to be provided in the TTL alignment method, it is difficult to construct such a correction optical system. For this reason, the TTL alignment method has difficulty enabling the mask pattern to be formed on the target workpiece with high accuracy while suppressing cost increase, and has difficulty obtaining extremely high alignment precision.

### SUMMARY OF THE INVENTION

The invention has been made in view of the foregoing situations. An object of the invention is to provide an exposure apparatus capable of obtaining extremely high alignment precision with its simple configuration.

One embodiment of the present invention provides an exposure apparatus which forms a predetermined mask pattern on a target workpiece through exposure by: casting exposure light upon a mask in which the pattern and a mask-side alignment mark are formed, and forming an image of the mask on the target workpiece by projecting the exposure light, which passes the mask, on the target workpiece through a projection lens, including: an alignment lighting unit configured to cast, as alignment light, light in a wavelength range included in the exposure light onto the mask-side alignment mark of the mask; and an alignment camera unit including an image pickup device for capturing images, and configured to receive the incident alignment light coming from the alignment lighting unit through the mask and the projection lens, characterized in that the alignment camera unit includes: an image formation optical system configured to form a mask-side alignment mark image by use of the incident alignment light in a dummy workpiece area located in a position which is different from the target workpiece and makes an optical positional relationship of the alignment light thereon with the mask equal to an optical positional relationship of the target workpiece with the mask; and an image pickup optical system configured to make an optical positional relationship of the target workpiece with the image pickup device and an optical positional relationship of the dummy workpiece area with the image pickup device equal to each other.

### BRIEF DESCRIPTION OF DRAWINGS

FIG. 1 is an explanatory diagram schematically showing a configuration of an exposure apparatus 10 of an embodiment of the present invention.

FIG. 2 is an explanatory diagram schematically showing a configuration of alignment lighting units 30 and alignment camera units 40 in the exposure apparatus 10.

FIG. 3 is an explanatory diagram for explaining a configuration of one alignment lighting unit 30 and a corresponding alignment camera unit 40.

FIGS. 4A to 4D are explanatory diagrams for explaining how the exposure apparatus 10 performs alignment. FIG. 4A schematically shows an image taken by a camera 44 in one of the alignment camera units 40. FIG. 4B schematically shows a positional relationship of a target workpiece 23 with the alignment camera unit 40 which are placed in a condition shown in FIG. 4A. FIG. 4C schematically shows an image which is taken by the camera 44 in the alignment camera unit 40 when the alignment is made. FIG. 4D schematically shows a positional relationship of the target workpiece 23 with the alignment camera unit 40 which are placed in a condition shown in FIG. 4C.

FIG. 5 is an explanatory diagram for explaining how the target workpiece 23 is aligned with a mask 18a through a projection optical system on the basis of a positional relationship between four mask-side align mark images 53 and four workpiece-side alignment marks 52.

### DESCRIPTION OF PREFERRED EMBODIMENTS

Descriptions will be hereinbelow provided for an embodiment of an exposure apparatus according to the invention while referring to the drawings.

### Embodiments

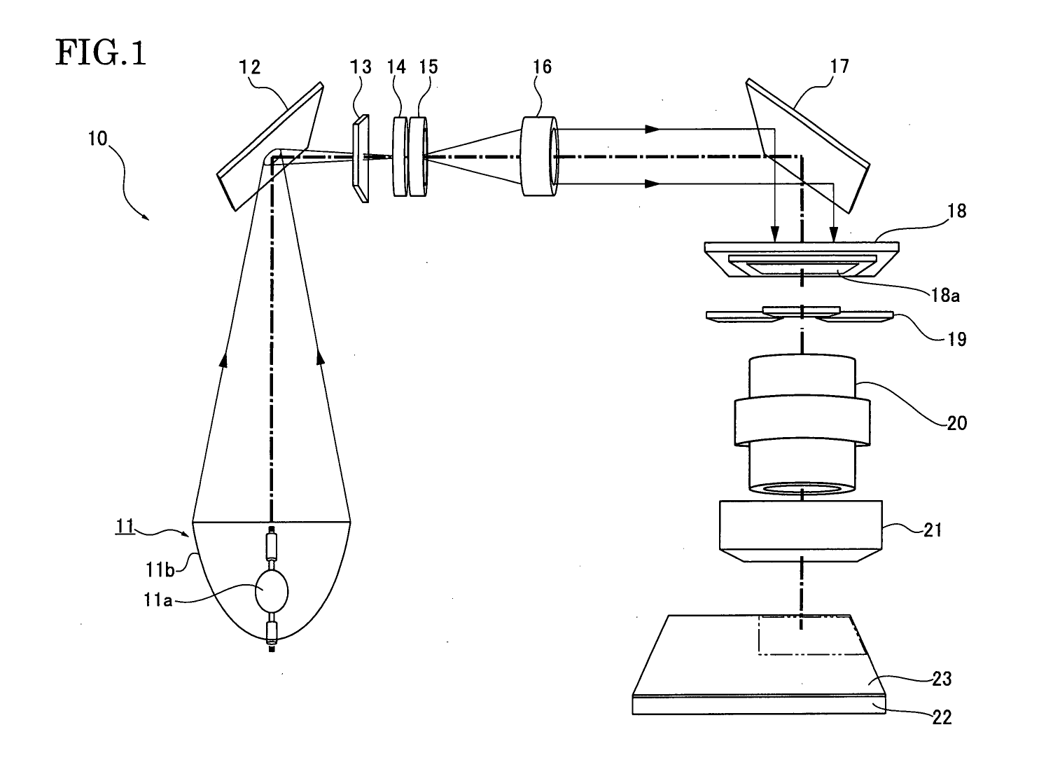

First of all, descriptions will be provided for a schematic configuration of an exposure apparatus 10 of the embodiment. FIG. 1 is an explanatory diagram schematically showing the configuration of the exposure apparatus 10 as an example of the exposure apparatus of the embodiment. As shown in FIG. 1, the exposure apparatus 10 includes, in order from the exit side in the direction of the optical axis, a light source 11, a cold mirror 12, an exposure shutter 13, an ultraviolet band-pass filter 14, an integrator lens 15, a collimator lens 16, a plane mirror 17, a mask stage 18, a mask blind 19, a projection lens 20, a magnification correcting unit 21, and a projection exposure stage 22. This exposure apparatus 10 uses ultraviolet light as exposure light.

The light source 11 is provided to cast the ultraviolet light serving as the exposure light to be used for light exposure. In this embodiment, the light source 11 is made with a mercury lamp 11a placed in a first focal position in an elliptic reflecting mirror (elliptic mirror) 11b. This light source 11 causes emission light, which is emitted by the mercury lamp 11a, to be reflected by the elliptic reflecting mirror 11b, and thereby causes the resultant light to travel to the cold mirror 12.

The cold mirror 12 allows a heat ray in an infrared range out of the incident light to pass the cold mirror 12, and reflects light in a different wavelength range. The cold mirror 12 is capable of separating the heat ray in the infrared range out of the incident light. For this reason, after separated from the heat ray in the infrared range by the cold mirror 12, the emission light from the light source 11 travels to the exposure shutter 13 or the ultraviolet band-pass filter 14.

The exposure shutter 13 can advance onto or retract from an optical path (an irradiation optical path, which will be described later) heading from the cold mirror 12 to the ultraviolet band-pass filter 14 for the purpose of making it possible to switch between the transmitting and blocking of the emission light reflected by the cold mirror 12. When retracted from the optical path, this exposure shutter 13 enables a target workpiece 23 to be exposed to light, as described later. When placed on the optical path, the exposure shutter 13 stops the target workpiece 23 from being exposed to light.

The ultraviolet band-pass filter 14 allows only the ultraviolet light out of the light incident on the ultraviolet band-pass filter 14 to pass the ultraviolet band-pass filter 14. In this embodiment, the ultraviolet band-pass filter 14 is formed of an i-line band-pass filter which allows the i-line at a wavelength of 365 nm, which is a spectral line of mercury, to pass the i-line band-pass filter. For this reason, the emission light reflected by the cold mirror 12 is turned by the ultraviolet band-pass filter 14 into light only in the wavelength range of the ultraviolet light (the i-line) (actually, light whose intensity is higher in and around the i-line wavelength range), and subsequently travels to the integrator lens 15. Incidentally, the h-line, a combination of the i-line and the h-line, or a wavelength between the i-line and the h-line may be used instead of the i-line.

The integrator lens 15 eliminates the illuminance unevenness of the incident light, and thereby makes an illuminance distribution which is uniform and bright throughout the illuminated surface including the peripheral portion. Thereby, the incident light which is the light only in the wavelength range of the ultraviolet light (the i-line) as a result of passing the ultraviolet band-pass filter 14 is turned by the integrator lens 15 into light having the uniform illuminance distribution, and subsequently travels to the collimator lens 16. Incidentally, even if this integrator lens 15 and the ultraviolet band-pass filter 14 are arranged in a reversed order, the same operations can be obtained.

The collimator lens 16 receives the incident light, and emits the light in the form of (a beam of) parallel rays of light. For this reason, the emission light which has the uniform illuminance distribution as a result of passing the integrator lens 15 is turned by the collimator lens 16 into parallel rays of light, and the parallel rays of light travel to the plane mirror 17. The parallel rays of light are reflected by the plane mirror 17, and subsequently travel to the mask stage 18.

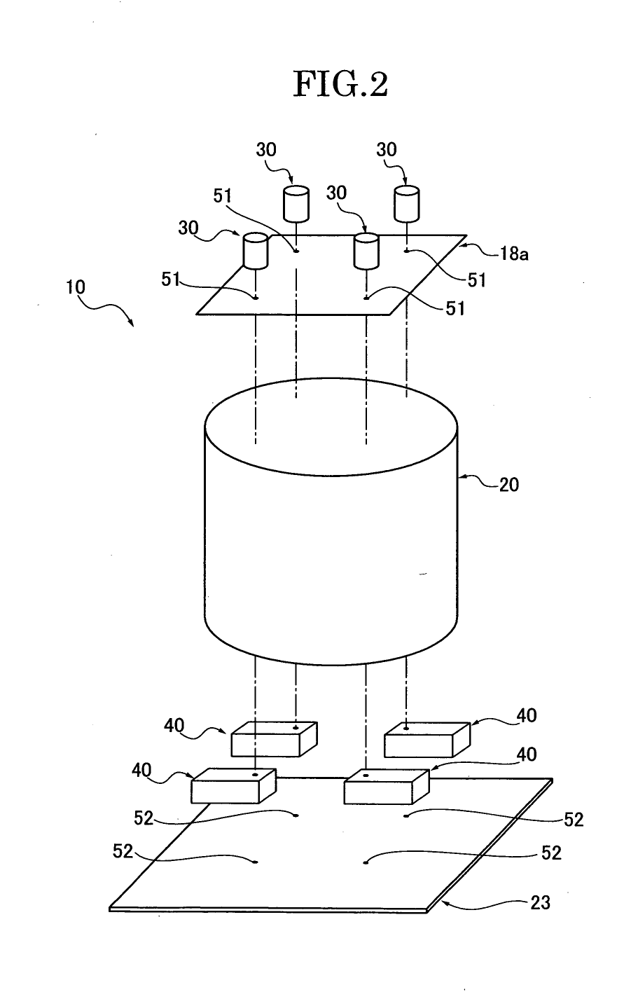

The mask stage 18 locates the mask 18a, in which a pattern is formed, on the optical path of the emission light having been reflected by the plane mirror 17, and concurrently holds the mask 18a movably in a direction orthogonal to the optical axis of the optical path. Although the illustration is omitted, the mask 18a can be detached from the mask stage 18. Accordingly, the mask 18a can be replaced with a mask in which a pattern different from that of the mask 18a is formed. In this embodiment, each of replaceable masks including the mask 18a is provided with four mask-side alignment marks 51 (see FIG. 2). These four mask-side alignment marks 51 have a positional relationship corresponding to four workpiece-side alignment marks 52 of the target workpiece 23 which will be described later. For this reason, the emission light reflected by the plane mirror 17 is made to have a shape which corresponds to the shape of the pattern formed in the mask 18a when transmitted through the mask 18a, and the resultant light travels to the projection lens 20.

With the foregoing configuration, in the exposure apparatus 10, the optical path which extends from the light source 11 to the plane mirror 17 via the cold mirror 12, the exposure shutter 13, the ultraviolet band-pass filter 14, the integrator lens 15 and the collimator 16 functions as an irradiation optical system for irradiating the mask 18a with the ultraviolet light (the i-line) serving as the exposure light.

The mask blind 19 is provided between the mask stage 18 and the projection lens 20. The mask blind 19 is provided to be capable of advancing onto and retracting from the optical path of the emission light having passed the mask 18a. The mask blind 19 advances onto the optical path in accordance with a mask pattern of the mask 18a depending on the necessity for the purpose of adequately forming an image of only a desired area of the mask pattern of the mask 18a on the target workpiece 23, which will be described later, placed on the projection exposure stage 22.

The projection lens 20 adequately transfers the pattern, which is formed in the mask 18a, onto the later-described target workpiece 23 on the projection exposure stage 22 through light exposure. The projection lens 20 forms an image (hereinafter referred to as a “mask pattern image”) of the pattern in the mask 18a held by the mask stage 18 on the surface of the later-described target workpiece 23 placed on the projection exposure stage 22 with the magnification changed depending on the necessity. In other words, the projection lens 20 regards the surface of the target workpiece 23 placed on the projection exposure stage 22 as an image formation surface, and places the image formation surface and the mask 18a in an optically conjugate positional relationship. Because, as described above, the exposure apparatus 10 uses the ultraviolet light (the i-line) as the exposure light, the projection lens 20 is set up in such a way that the aberration of the projection lens 20 is corrected with respect to the ultraviolet light (the i-line) serving as the exposure light with high precision. For this reason, when the emission light having passed the mask 18a falls into the projection lens 20 after passing the mask 18a, the projection lens 20 adequately forms the mask pattern image of the mask 18a on the image formation surface (i.e., on the target workpiece 23, which will be described later) on the projection exposure stage 22.

The magnification correcting unit 21 is provided between the projection lens 20 and the projection exposure stage 22. The magnification correcting unit 21 changes the shape of the mask pattern image, which is intended to be formed on the image formation surface on the projection exposure stage 22, in accordance with the deformation of the later-described target workpiece 23 placed on the projection exposure stage 22. This magnification correcting unit 21 changes the shape of the mask pattern image on the image formation surface by changing the magnification in an arbitrary direction depending on the necessity in a plan view which is orthogonal to the optical path. The modification correcting unit 21 can be realized, for example, with a configuration in which: multiple glass plates are arranged in parallel with the direction of the optical path; and each glass plate is bent and/or rotated depending on the necessity.

As described above, in the exposure apparatus 10, the mask blind 19, the projection lens 20 and the magnification correcting unit 21 collectively function as an projection optical system for forming the mask pattern image by use of the ultraviolet light serving as the exposure light and projected through the mask 18a in which the predetermined pattern is formed, on the image formation surface (i.e., on the target workpiece 23, which will be described later) on the projection exposure stage 22.

The projection exposure stage 22 has the target workpiece 23 placed in order to expose the mask pattern to light. This projection exposure stage 22 is capable of holding the target workpiece 23 in such a way that the surface of the target workpiece 23 placed on the projection exposure stage 22 coincides with the image formation surface of the projection lens 20, and concurrently capable of moving the target workpiece 23, which is held by an projection exposure stage 23, in a plane orthogonal to a projection optical path. In this embodiment, the moving of the target workpiece 23 on the projection exposure stage 22 is achieved under control of a drive controller (not illustrated) provided inside the projection exposure stage 22. It should be noted that the moving of the target workpiece 23 on the projection exposure stage 22 may be achieved manually. In this embodiment, the target workpiece 23 is placed on the projection exposure stage 22 while in a state of being pre-aligned. This pre-alignment is achieved with the target workpiece 23 used as the reference position of the projection optical system, and does not satisfy the positional precision required for the exposure position of the mask pattern relative to the target workpiece 23.

The target workpiece 23 is formed by applying or attaching a photosensitive material such as a photoresist, which is optically reactive to the ultraviolet light (the i-line), to a silicon wafer, a glass board, a printed board or the like. For this reason, the target workpiece 23 can be exposed to the ultraviolet (i-line) radiation. In this embodiment, the target workpiece 23 is provided with the four workpiece-side alignment marks 52 (see FIG. 2). In this embodiment, these four workpiece-side alignment marks 52 are formed as the respective recesses in the surface of the target workpiece 23, and are provided corresponding to the above-mentioned four mask-side alignment marks 51 on a one-to-one basis.

The exposure apparatus 10 evenly irradiates the mask 18a, which is held by the mask stage 18, with the ultraviolet light (the i-line) when the emission light exiting from the light source 11 reaches the mask stage 18 via the cold mirror 12, the ultraviolet band-pass filter 14, the integrator lens 15, the collimator lens 16 and the plane mirror 17 in the irradiation optical system. Thereby, the exposure apparatus 10 adequately forms the mask pattern image on the image formation surface on the projection exposure stage 22 with the ultraviolet light (the i-line) by use of the function of the projection optical system, that is to say, the combination of the mask blind 19, the projection lens 20 and the magnification correcting unit 21. Thereby, the exposure apparatus 10 is capable of adequately transferring the mask pattern image on the target workpiece 23 through exposure by setting the target workpiece 23 in an adequate position along the image formation surface. The exposure apparatus 10 is capable of adjusting (aligning) the position of the target workpiece 23 to this mask pattern image, that is to say, the position of the target workpiece 23 to the mask 18a optically passing the projection optical system (mainly, the projection lens 20) by moving the target workpiece 23, which is held by the projection exposure stage 22, on the image formation surface depending the necessity.

As shown in FIG. 2, the exposure apparatus 10 of the embodiment is provided with four alignment lighting units 30 and four alignment camera units 40 in order to align the position of the target workpiece 23 with the mask 18a optically passing the projection optical system. The provision of the four alignment lighting units 30 and the four alignment camera units 40 is based on the configuration in which, as described above, the mask 18a is provided with the four mask-side alignment marks 51 while the target workpiece 23 is provided with the four workpiece-side alignment marks 52.

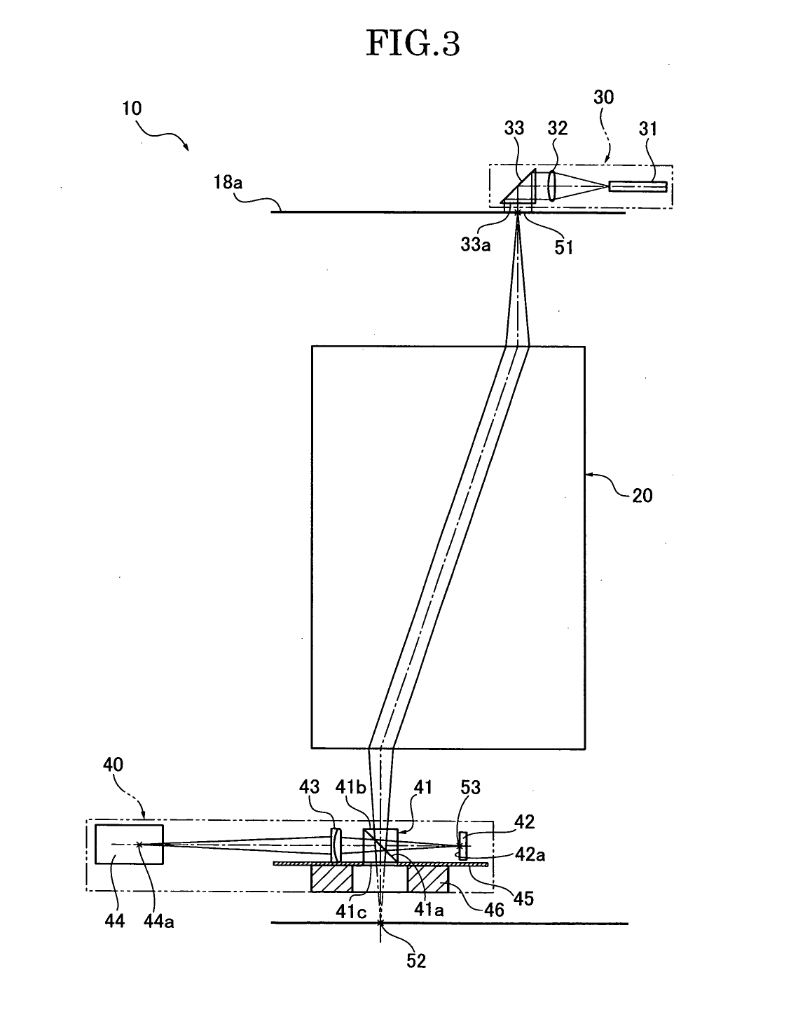

The four alignment lighting units 30 are provided respectively corresponding to the four mask-side alignment marks 51, while the four alignment camera units 40 are provided respectively corresponding to the four workpiece-side alignment marks 52. In other words, one alignment lighting unit 30 and one alignment camera unit 40 are paired with each other corresponding to one mask-side alignment mark 51 and one workpiece-side alignment mark 52 which are placed in a correspondence relationship. In this respect, descriptions will be provided for one alignment lighting unit 30 and the corresponding alignment camera unit 40 by use of FIG. 3 with consideration given to the configuration in which: the alignment lighting units 30 have the same configuration; the alignment camera units 40 have the same configuration; and four pairs each consisting of one alignment lighting unit 30 and the corresponding alignment camera unit 40 are placed in the same correspondence relationship.

The alignment lighting unit 30 includes a light source 31, a collimator lens 32, and a reflecting prism 33. The light source 31 is capable of emitting light, which is in the same wavelength range as is the exposure light, as alignment light. In this embodiment, the light source 31 is capable of emitting the ultraviolet light (the i-line). The collimator lens 32 receives the incident light, and emits the light in the form of (a beam of) parallel rays of light. The collimator lens 32 causes the ultraviolet light (the i-line) exiting from the light source 31 to travel to the reflecting prism 33 in the form of the parallel rays of light. The reflecting prism 33 changes the direction of the travel of the ultraviolet light (the i-line), which has been turned into the parallel rays of light by the collimator lens 32, to a direction orthogonal to the mask 18a. The reflecting prism 33 forms an exit surface 33a of the ultraviolet light (the i-line) in the alignment lighting unit 30. Incidentally, a reflecting mirror may be used instead of the prism 33. Otherwise, a linear arrangement may be employed by use of neither the prism nor the mirror.

The alignment lighting unit 30 is provided to be capable of advancing onto and retracting from the irradiation optical path in the vicinity of the mask 18a. When the alignment is performed, the exit surface 33a is arranged to be opposed to the corresponding mask-side alignment mark 51 in the mask 18a. The alignment lighting unit 30 is capable of emitting the alignment light, which is in the form of parallel rays of light in the direction of the irradiation optical path, to the corresponding mask-side alignment mark 51. Since the alignment light is the ultraviolet light (the i-line), the mask-side alignment mark image 53 is adequately formed in a position on the image formation surface, which corresponds to the magnification set in the projection lens 20 (see the alignment light represented by the chain line. That is because: as described above, the projection lens 20 is set up in such a way that the aberration of the projection lens 20 is corrected with respect to the ultraviolet light (the i-line) with high precision, and the image formation surface and the mask 18a are placed in the optically conjugate positional relationship. The alignment camera unit 40 is provided between the projection lens 20 and the target workpiece 23 on the optical path of the alignment light emitted by the alignment lighting unit 30 and passing the mask 18a and the projection lens 20.

The alignment camera unit 40 includes a complex prism 41, a mirror 42, an image formation lens 43, a camera 44, a light-blocking member 45 and a ring illuminator 46.

The complex prism 41 has a joint surface 41a which tilts at an angle of 45 degrees to the optical axis of the projection. This joint surface 41a has a function of serving as a half mirror, and reflects part of the light having travelled while allowing the other part of the light to pass the joint surface 41a. The upper end surface of this complex prism 41 forms an incident surface 41b of the alignment camera unit 40, and an ultraviolet light blocking film configured to block the ultraviolet light (the i-line) serving as the alignment light from passing the film and to allow the visible light to pass the film is provided to a lower end surface 41c. This ultraviolet light blocking film can be formed by vapor-depositing a coating film serving as a long-pass filter which allows light in wavelength range greater than the ultraviolet light (the i-line) to pass the filter. For this reason, in the complex prism 41, the joint surface 41a reflects the alignment light incident from the incident surface 41b, and thus causes the reflected light to travel in a direction at a right angle; and concurrently, the complex prism 41 prevents the alignment light from reaching the target workpiece 23 after passing the lower end surface 41c. The mirror 42 is provided in a direction of the travel of the alignment light after the alignment light received from the incident surface 41b is reflected by the joint surface 41a.

The mirror 42 is provided to form a reflection surface 42a thereon, which is shaped like a flat surface along a plane orthogonal to the optical path of the light reflected by the joint surface 41a and is placed in a position where the reflection surface 42a has an optically conjugate positional relationship with the mask 18a on the optical path of the light reflected by the joint surface 41a after passing the projection lens 20. For this reason, once the alignment light from the alignment lighting unit 30 is cast on the mask-side alignment mark 51 of the mask 18a, the mask-side alignment mark image 53 is adequately formed on the reflection surface 42a of the mirror 42 in a position corresponding to the magnification set in the projection lens 20. Accordingly, in the alignment camera unit 40, the reflection surface 42a of the mirror 42 is used as a dummy workpiece area which is located in a position different from the target workpiece 23 and makes an optical positional relationship of the incident alignment light thereon with the mask 18a equal to an optical positional relationship of the target workpiece 23 with the mask 18a. Hence, the mirror 42 functions as a dummy workpiece part. Incidentally, a dummy board, a white plate or the like may be used as the dummy workpiece part. Furthermore, in the alignment camera unit 40, the mirror 42 and the joint surface 41a of the complex prism 41 collectively function as an image formation optical system for forming the mask-side alignment mark image 53 of the incident alignment light. The reflection surface 42a of the mirror 42 is capable of forming a dummy workpiece area having the same size dimensions as an area (hereinafter referred to as a “virtual image formation area”) in the target workpiece 23 (its surface), on which the mask-side alignment mark image 53 may be formed if the alignment light entering the complex prism 41 from the incident surface 41b straightly reaches the target workpiece 23 through the joint surface 41a. This virtual image formation area and the dummy workpiece area can have as large dimensions as the image formation area supported by the projection lens 20 at maximum. In this embodiment, the upper limit is prescribed by the size dimensions of the surfaces of the complex prism 41. The image formation lens 43 and the camera 44 are provided in a direction of the travel of the alignment light reflected by the mirror 42 (the reflection surface 42a), and in a position across the complex prism 41 (its joint surface 41a) from the mirror 41.

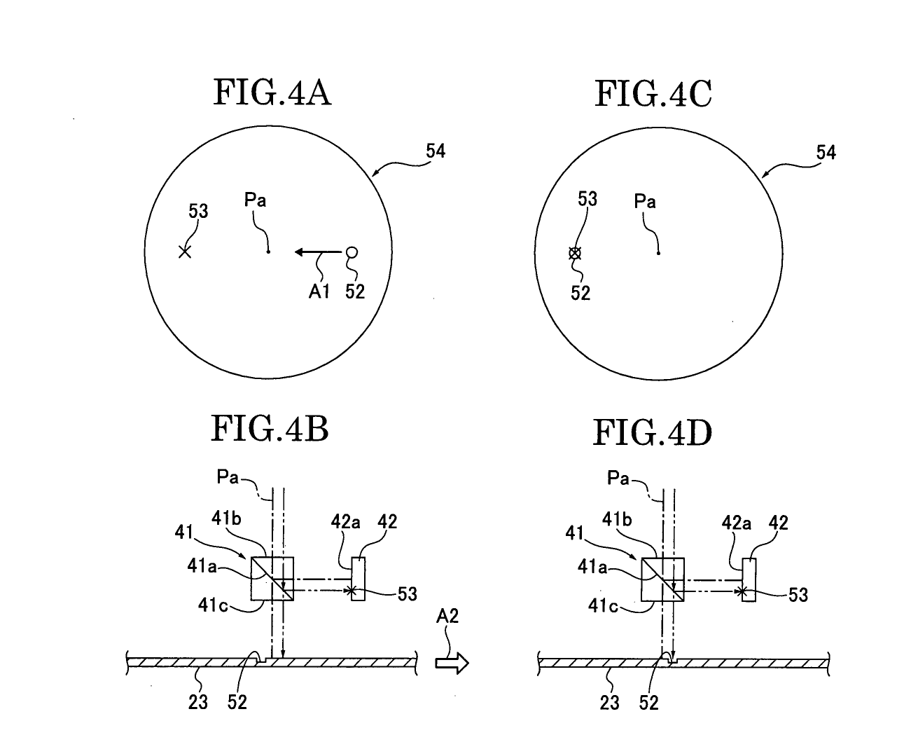

The image formation lens 43 is provided in order that the camera 44 should capture an image 54 (see FIGS. 4A and 4C) of the mask-side alignment mark image 53 formed on the reflection surface 42a of the mirror 42 and the workpiece-side alignment mark 52 provided in the target workpiece 23. The image formation lens 43 is set up in such a way that, in cooperation with an optical system (not illustrated) of the camera 44, the image formation lens 43 places the reflection surface 42a of the mirror 42 and an image pickup surface 44a of the camera 44 in an optically conjugate positional relationship on an optical path which extends from the mirror 42 to the camera 44 via the complex prism 41 (its joint surface 41a). Furthermore, the image formation lens 43 is set up in such a way that, in cooperation with the optical system (not illustrated) of the camera 44, the image formation lens 43 places the top surface (image formation surface) of the target workpiece 23 and the image pickup surface 44a of the camera 44 in an optically conjugate positional relationship on an optical path which extends from the target workpiece 23 to the camera 44 after reflected by the joint surface 41a of the complex prism 41. Thereby, in the alignment camera unit 40, the image formation lens 43, the optical system (not illustrated) of the camera 44 and the joint surface 41a of the complex prism 41 collectively function as an image pickup optical system for making an optical relationship of the target workpiece 23 with the camera 44 and an optical relationship of the reflection surface 42a (the dummy workpiece area) of the mirror 42 with the camera 44 equal to each other.

The camera 44 is an image pickup device for capturing an image, and is sensitive to at least the wavelength range of the alignment light and a wavelength range of light to be emitted by the ring illuminator 46. In this embodiment, the camera 44 is sensitive to the wavelength range of the ultraviolet light (the i-line) serving as the alignment light, which is the same as the wavelength range included in the exposure light, and the wavelength range of the visible light. The camera 44 is capable of capturing an image of an area which has the same size dimension as the above-described virtual image formation area. In this embodiment, the upper limit is prescribed by the size dimensions of the respective surfaces of the complex prism 41. In this embodiment, the alignment camera unit 40 is set up in such a way that an area to be captured by the camera 44 should be an area which is larger than the positional displacement of the pre-aligned target workpiece 23 from the target workpiece 23 which would be placed in its adequate position and the positional displacement of the pre-aligned target workpiece 23 from the mask 18a. The light blocking member 45 is provided to the lower end surface 41c-side portion of the complex prism 41 for guiding the light to the camera 44.

The light blocking member 45 prevents the alignment light, which exits from the alignment lighting unit 30, from being cast on the target workpiece 23 without hindering the camera 45 from capturing an image of the target workpiece 23 through the complex prism 41. In this embodiment, the light blocking member 45 is formed from a flat plate-shaped member which blocks at least the ultraviolet light (the i-line) from passing the member, and is provided to surround the lower end surface 41c of the complex prism 41. Hence, the light blocking member 45 functions as an exposure light blocking portion for preventing the alignment light, which is light in the wavelength range included in the exposure light, from reaching the target workpiece 23. The ring illuminator 46 is provided between the light blocking member 45 and the target workpiece 23.

The ring illuminator 46 is an illumination unit provided to surround the center of a photographing optical path, which extends from the target workpiece 23 to the camera 44 via the joint surface 41a of the complex prism 41, for the purpose of illuminating the top of the target workpiece 23 with the non-exposure light. In this embodiment, the ring illuminator 46 is capable of emitting light in a wavelength range of visible light. The ring illuminator 46 illuminates an inner peripheral portion of the corresponding workpiece-side alignment mark 52 formed as a recess in the top surface of the target workpiece 23, and thus enhances the visibility of the workpiece-side alignment mark 52 in the image 54 (see FIGS. 4A to 4D) captured by the camera 44. Incidentally, the ring illuminator 46 suffices as long as the ring illuminator 46 illuminates the top of the target workpiece 23 with the non-exposure light for the purpose of enhancing the visibility of the workpiece-side alignment mark 52 in the image 54 (see FIGS. 4A to 4D) captured by the camera 44 (for example, even if the ring illuminator 46 performs coaxial epi-illumination). The ring illuminator 46 is not limited to this embodiment.

The alignment camera unit 40 is provided to be capable of advancing onto and retracting from the projection optical path between the projection lens 20 and the target workpiece 23. When the alignment is performed, the alignment camera unit 40 is placed in such a way that: the incident surface 41b can receive the alignment light coming from the corresponding alignment lighting unit 30 through the projection lens 20; and the lower end surface 41c of the complex prism 41 is opposed to the workpiece-side alignment mark 52 of the target workpiece 23 when viewed in the direction of the irradiation optical axis. In this embodiment, the alignment camera unit 40 is arranged in accordance with the position of the workpiece-side alignment mark 52 of the target workpiece 23 which is placed on the projection exposure stage 22 while in the state of being pre-aligned. Thereby, the mask-side alignment mark image 53 formed on the reflection surface 42a of the mirror 42 and the workpiece-side alignment mark 52 of the target workpiece 23 can be positioned within the image captured by the camera 44 (FIGS. 4A to 4D). That is because, as described above, the area capable of being captured by the camera 44 is set larger than the positional displacement of the pre-aligned target workpiece 23 from the target workpiece 23 which would be placed in its adequate position and the positional displacement of the pre-aligned target workpiece 23 from the mask 18a.

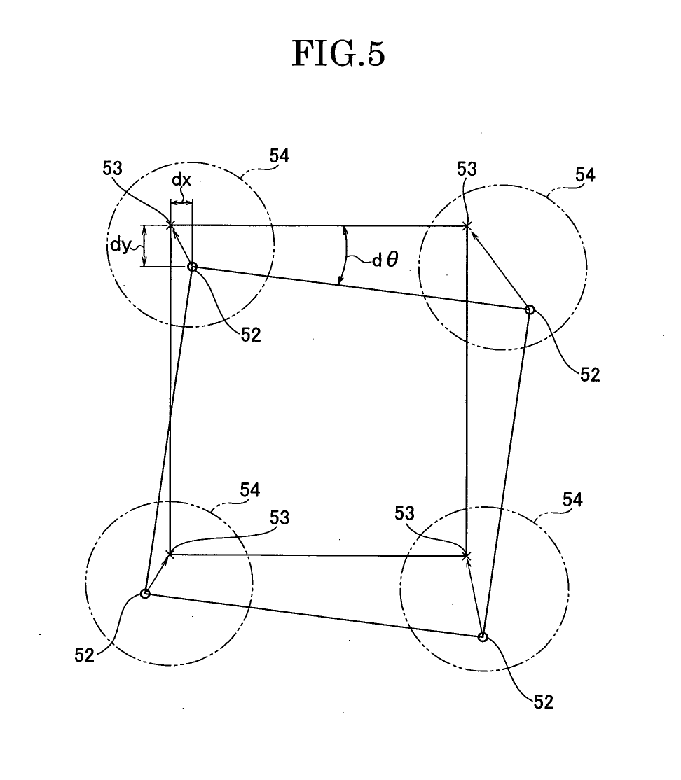

Next, using FIGS. 4 and 5, descriptions will be provided for how the exposure apparatus 10 of the embodiment aligns the position of the target workpiece 23 with the mask 18a by use of the alignment lighting units 30 and the alignment camera units 40. It should be noted that, although FIGS. 4 and 5 emphatically show the positional displacement between one mask-side alignment mark image 53 and the corresponding workpiece-side alignment mark 52 (the positional displacement between the mask 18a and the target workpiece 23) for the purpose of making the alignment method understood easily, the shown positional displacement does not necessarily agree with the actual displacement. Furthermore, in FIGS. 4 and 5, the mask-side alignment mark image 53 is indicated by a cross (x), and the workpiece-side alignment mark 52 is indicated by a white circle (o) for the purpose of making the alignment method understood easily. In FIGS. 4 and 5, the image to be captured by the camera 44 is a circle denoted by reference sign 54, and the center position of the image 54 is defined as a photographing optical axis Pa.

The exposure apparatus 10 starts to align the position of the target workpiece 23 with the mask 18a placed on the mask stage 18, and with the target workpiece 23 placed on the projection exposure stage 22 while in the state of being pre-aligned. In order for the exposure apparatus 10 to perform the alignment, as described above, the exit surface 33a of each alignment lighting unit 30 is arranged to be opposed to the corresponding mask-side alignment mark 51 of the mask 18a, and the corresponding alignment camera unit 40 is arranged in accordance with the position of the corresponding workpiece-side alignment mark 52 of the target workpiece 23. While in this state, the alignment light (the ultraviolet light (the i-line) is emitted by the alignment lighting unit 30, and the alignment camera unit 40 starts to cause the ring illuminator 46 to perform illumination, and to cause the camera 44 to take a picture. This alignment operation is carried out under control of the drive controller, whose illustration is omitted, in a coordinated manner. Thereby, as described above, the mask-side alignment mark image 53 formed on the reflection surface 42a of the mirror 42 and the workpiece-side alignment mark 52 of the target workpiece 23 are situated within the image 54 captured by the camera 44 of the alignment camera unit 40 because of the setting of the alignment lighting unit 30 and the alignment camera unit 40, as shown in FIG. 4A.

In this respect, in the alignment camera unit 40, as described above, the optical positional relationship of the reflection surface 42a of the mirror 42 with the mask 18a and the optical positional relationship of the top surface of the target workpiece 23 with the mask 18a are set equal to each other which is observed through the projection lens 20. Furthermore, as described above, the optical positional relationship of the reflection surface 42a of the mirror 42 with the image pickup surface 44a of the camera 44 and the optical positional relationship of the top surface of the target workpiece 23 with the image pickup surface 44a of the camera 44 are set equal to each other when observed through the image formation lens 43 and the optical system (not illustrated) of the camera 44.

For this reason, the alignment camera unit 40 is capable of displaying the mask-side alignment mark image 53, which is formed in the dummy workpiece area, in the image 54 captured by the camera 44 while causing the mask-side alignment mark image 53 to overlap the target workpiece 23. Accordingly, the exposure apparatus 10 is capable of adequately setting up the position of the target workpiece 23 relative to the mask 18a, which is captured through the projection optical system, by moving the mask 18a and the target workpiece 23 relative to each other in the image 54 in such a way that the mask-side alignment mark image 53 and the workpiece-side alignment mark 52 should coincide with each other. In this embodiment, the position of the target workpiece 23 relative to the mask 18a is adequately set up by moving the target workpiece 23, which is held by the projection exposure stage 22, along the plane orthogonal to the projection optical path depending on the necessity while keeping the mask 18a, which is held by the mask stage 18, fixed there.

In the image 54 shown in FIG. 4A, the mask-side alignment mark image 53, which is formed by use of the alignment light, is displaced with respect to the photographing optical axis Pa. That is because this displacement occurs to the shift of the position of the mask 18a from the alignment camera unit 40 which is arranged in accordance with the position of the pre-aligned target workpiece 23. Furthermore, in the image 54 shown in FIG. 4A, the workpiece-side alignment mark 52 is displaced with respect to the photographing optical axis Pa. That is because, although the alignment camera unit 40 is arranged in accordance with the position of the pre-aligned target workpiece 23, the positional displacement occurs due to the precision of the pre-alignment.

In this respect, in this embodiment, it does not matter that the positions of the mask-side alignment mark image 53 and the workpiece-side alignment mark 52 are displaced with respect to the photographing optical axis Pa in the image 54, because, as described above, the adjustment of the relative positions of the mask 18a and the target workpiece 23 through the projection optical system serves for the alignment purpose. For this reason, the target workpiece 23 is moved along the plane orthogonal to the irradiation optical path (see an arrow A2 in FIG. 4B) in such a way that the workpiece-side alignment mark 52 is situated on the mask-side alignment mark image 53 in the image 54 (see an arrow A1 in FIG. 4A). Once, as shown in FIG. 4C, the workpiece-side alignment mark 52 and the mask-side alignment mark image 53 coincide with each other in the image 54 as a result of this movement, the workpiece-side alignment mark 52 of the target workpiece 23 coincides with a position in which the mask-side alignment mark image is formed through the irradiation of the alignment lighting unit 30, as shown in FIG. 4D, when assuming that no alignment camera unit 40 exists. Thereby, the position of the target workpiece 23 can be aligned with the mask 18a through the projection optical system.

In the exposure apparatus 10 of this embodiment, as described above, the mask 18a is provided with the four mask-side alignment marks 51, and the target workpiece 23 is provided with the four workpiece-side alignment marks 52. Furthermore, the four alignment lighting units 30 are provided corresponding to the respective four mask-side alignment marks 51, and the four alignment camera units 40 are provided to correspond to the four respective workpiece-side alignment marks 52. Thereby, the exposure apparatus 10 calculates a positional displacement dx of the target workpiece 23 from the mask 18a through the projection optical system in an x direction, a positional displacement dy of the target workpiece 23 from the mask 18a through the projection optical system in a y direction orthogonal to the x direction, and an angle dθ of a rotational displacement of the target workpiece 23 from the mask 18a through the projection optical system in the x-y plane, on the basis of the positional relationship between the mask-side alignment mark images 53 in the four images captured by the cameras 44 of the respective alignment camera units 40 and the workpiece-side alignment marks 52, as shown in FIG. 5. In this embodiment, the calculation of these displacements is achieved by the image analysis carried out by the above-mentioned drive controller (not illustrated). Subsequently, the target workpiece 23, which the projection exposure stage 22 holds, is moved along the plane orthogonal to the projection optical path in such a way that the movement offsets the calculated displacements. Thereby, the alignment is completed, and the position of the target workpiece 23 with respect to the mask 18a through the projection optical system can be adequately set up.

As described above, the exposure apparatus 10 of the embodiment uses the ultraviolet light (the i-line), which is the same as that used as the exposure light, as the alignment light, and performs the alignment by causing the alignment light to pass the projection lens 20 for the exposure. For this reason, the exposure apparatus 10 is capable of adjusting the position of the target workpiece 23 for the exposure with respect to the mask 18a through the projection optical system with extremely high precision.

Furthermore, the exposure apparatus 10 is configured in such a manner that: the dummy workpiece part is formed on the mirror 42 in such a way that the optical positional relationship of the reflection surface 42a of each mirror 42 with the mask 18a and the optical positional relationship of the top surface of the target workpiece 23 with the mask 18a should be made equal to each other which is observed through the projection lens 20; and each mask-side alignment mark image 53 is formed on the corresponding mirror 42 (its reflection surface 42a) by use of the alignment light which is the ultraviolet light (the i-line). For this reason, the exposure apparatus 10 is capable of performing the alignment by use of the alignment light cast through the projection lens 20 without allowing the alignment light to reach the target workpiece 23.

Moreover, the exposure apparatus 10 is capable of displaying each mask-side alignment mark image 53, which is formed in the corresponding dummy workpiece area, in the image 54 captured by the corresponding camera 44 while causing the mask-side alignment mark image 53 to overlap the target workpiece 23. For this reason, the exposure apparatus 10 is capable of performing the alignment on the basis of the direct positional relationship between the mask-side alignment mark image 53 and the corresponding workpiece-side alignment mark 52 in the image 54 by causing the alignment light to pass the projection lens 20, which serves as the projection optical system, without allowing the alignment light to reach the target workpiece 23.

The exposure apparatus 10 prevents the alignment light, which is the ultraviolet light (the i-line), from reaching the target workpiece 23 by use of the ultraviolet light blocking film and the light blocking member 45 provided to the lower end surface 41c of the complex prism 41 in each alignment camera unit 40 receiving the alignment light. For this reason, the exposure apparatus 10 is capable of preventing the target workpiece 23 from being exposed to light through the alignment.

In the exposure apparatus 10, each alignment camera unit 40 is provided with the light blocking member 45 in such a way that the light blocking member 45 surrounds the lower end surface 41c of the corresponding complex prism 41. For this reason, even if the alignment light exiting from the each alignment lighting unit 30 is off the incident surface 41b due to the occurrence of an unexpected affair, the exposure apparatus 10 can prevent the alignment light, which is the ultraviolet light (the i-line), from reaching the target workpiece 23. Accordingly, the exposure apparatus 10 is capable of preventing the target workpiece 23 from being exposed to the light through the alignment.

In the exposure apparatus 10, each alignment lighting unit 30 is arranged in such a way that its exit surface 33a is opposed to the corresponding mask-side alignment mark 51 of the mask 18a, and each alignment camera unit 40 is arranged in accordance with the position of the corresponding workpiece-side alignment mark 52 of the target workpiece 23 which is placed on the projection exposure stage 22 while in the state of being pre-aligned. Thereby, the exposure apparatus 10 is capable of positioning the corresponding mask-side alignment mark image 53 and the workpiece-side alignment mark 52 in the image 54 captured by the camera 44 of the corresponding alignment camera unit 40. Accordingly, the exposure apparatus 10 is capable of making the preparatory work for the alignment easier.

In the exposure apparatus 10, it suffices that the projection lens 20 be set up in such a way that the aberration of the projection lens 20 is corrected with respect to only the ultraviolet light (the i-line), which is used as the exposure light, with high precision. For this reason, this setup enables the exposure apparatus 10 to have a high-precision optical performance much more easily than a setup in which the aberration is corrected with two wavelengths for the purpose of employing the TTL alignment method. Accordingly, the exposure apparatus 10 is capable of forming the mask pattern on the target workpiece 23 with extremely high precision.

In the exposure apparatus 10, each camera 44 is sensitive to the light in the wavelength range of the visible light, and the ring illuminators 46 each for illuminating the top of the target workpiece 23 with the light in the wavelength range of the visible light are provided. For this reason, the exposure apparatus 10 makes it possible to recognize the position of each workpiece-side alignment mark 52 in the corresponding image 54 more securely and clearly (see FIGS. 4A to 4D).

In the exposure apparatus 10, each mirror 42 is used as the dummy workpiece part. For this reason, the exposure apparatus 10 makes it possible to recognize the position of each mask-side alignment mark image 53, which is formed in the dummy workpiece area, in the corresponding image 54 more securely and clearly (see FIGS. 4A to 4D).

In sum, the exposure apparatus 10 according to the embodiment is capable of obtaining extremely high alignment precision through its simple configuration.

With regard to the foregoing embodiment, the descriptions have been provided for the exposure apparatus 10 as an example of the exposure apparatus according to the invention. However, it suffices if the exposure apparatus includes: alignment lighting units capable of casting alignment light, for which the exposure light is used, upon the respective mask-side alignment marks of the mask; and alignment camera units including the respective image pickup devices for capturing images, the alignment light emitted from the alignment lighting units, and received by the alignment camera units through the mask and the projection lens, the exposure apparatus in which each alignment camera unit includes: an image formation optical system configured to form an mask-side alignment mark image in a dummy workpiece area by use of the alignment light, the dummy workpiece area configured to make the optical positional relationship of the incident alignment light with the mask equal between a position of the target workpiece and a position different from the position of the target workpiece; and an image pickup optical system configured to make the optical positional relationship of the target workpiece with the image pickup device and the optical positional relationship of the dummy workpiece area with the image pickup device equal to each other. The exposure apparatus is not limited to the above-described embodiment.

Furthermore, in the foregoing embodiment, the light in the wavelength range of the ultraviolet light (the i-line) is used as the exposure light, and the light in the wavelength range of the visible light is used as the non-exposure light for illuminating the target workpiece. However, light in the different wavelength range may be used as the exposure light and the non-exposure light. The type of light is not limited to the foregoing embodiment.

Moreover, in the foregoing embodiment, the four mask-side alignment marks 51 and the four workpiece-side alignment marks 52 are provided; the four alignment lighting units 30 are provided corresponding to the respective mask-side alignment marks 51; and the four alignment camera units 40 are provided corresponding to the respective workpiece-side alignment marks 52. However, it suffices if there is provided at least one set consisting of one mask-side alignment mark, one workpiece-side alignment mark, one alignment lighting unit and one alignment camera unit which enables the position of the target workpiece 23 to be adequately set up with respect to the, mask 18a through the projection optical system. The number of sets is not limited to the above-described embodiment.

In the foregoing embodiment, each lower end surface 41c is provided with the ultraviolet light blocking film which serves as the exposure light blocking portion. Any exposure light blocking portion suffices if the exposure light blocking portion prevents the target workpiece 23 from being irradiated with the alignment light from the corresponding alignment lighting unit 30 without hindering the corresponding camera 44 from capturing the image of the target workpiece 23 through the corresponding complex prism 41. The exposure light blocking portion is not limited to the above-described embodiment. In other words, it suffices if this exposure light blocking portion blocks the alignment light in the wavelength range included in the exposure light from passing the exposure light blocking portion and allows the light in the wavelength range of the non-exposure light to pass the exposure light blocking portion, is the non-exposure light being used for the corresponding camera 44 to capture the image of the target workpiece 23 (the corresponding workpiece-side alignment mark 52). In addition, it suffices that the exposure light blocking portion has the foregoing action. For this reason, the exposure light blocking portion does not have to be provided to the lower end portion 41 c of the complex prism 41. For example, as a filter, the exposure light blocking portion may be provided to the upper or lower end portion surface of the ring illuminator 46. The exposure light blocking portion is not limited to the above-described embodiment.

The foregoing descriptions have been provided for the exposure apparatus of the invention on the basis of its embodiments. A specific configuration of the exposure apparatus is not limited to the examples or the embodiments. Design change, addition or the like is acceptable as long as the design change, addition or the like does not depart from the gist of the invention.

The exposure apparatus of the embodiment uses the light in the wavelength range, which is included in the exposure light, as the alignment light, and performs the alignment by causing the alignment light to pass the projection lens for the exposure. For this reason, the exposure apparatus is capable of adjusting the position of the target workpiece for the exposure with respect to the mask through the projection optical system with extremely high precision.

In addition, the exposure apparatus is configured in such a way that the mask-side alignment mark image is formed in the dummy workpiece area by use of the alignment light. For this reason, the exposure apparatus is capable of performing the alignment by use of the alignment light having passed the projection lens without allowing the alignment light to reach the target workpiece.

Furthermore, the exposure apparatus is capable of displaying the mask-side alignment mark image, which is formed in the dummy workpiece area, in the image captured by the image pickup device while causing the mask-side alignment mark image to overlap the target workpiece. For this reason, the exposure apparatus is capable of performing the alignment on the basis of the direct positional relationship of the mask-side alignment mark image on the target workpiece in the image by causing the alignment light to pass the projection lens serving as the projection optical system without allowing the alignment light to reach the target workpiece.

It suffices that the exposure apparatus be set in such a way that the aberration of the projection lens is corrected with respect to only the exposure light with high precision. This setup enables the exposure apparatus to have a high-precision optical performance much more easily than a setup in which the aberration is corrected with respect to two wavelengths for the purpose of employing the TTL alignment method. Accordingly, the exposure apparatus is capable of forming the mask pattern on the target workpiece with extremely high precision.

In addition to the foregoing configuration, the image formation optical system includes: the dummy workpiece portion forming the flat surface in the dummy workpiece area; and the reflection portion configured to cause the alignment light to travel toward the dummy workpiece portion, the alignment light coming from the alignment lighting unit through the mask and the projection lens, and received by the alignment camera unit. The mask and the dummy workpiece portion are placed in the optically conjugate positional relationship on the optical path passing the projection lens and the reflection portion. Thereby, the image formation optical system can be formed with the simple configuration.

In addition to the foregoing configuration, the reflection portion is the half-mirror; the image pickup optical system includes the reflection portion, and the image formation lens provided on the optical path which extends from the target workpiece to the image pickup device via the reflection portion. The dummy workpiece portion and the image pickup device are placed in the optically conjugate positional relationship on the optical path passing the reflection portion. The target workpiece and the image pickup device are placed in the optically conjugate positional relationship on the optical path via the reflection portion. Thereby, the image pickup optical system can be formed with the simple configuration.

In addition to the foregoing configuration, the alignment camera unit includes the exposure light blocking portion configured to prevent the incident alignment light from reaching the target workpiece. Thereby, it is possible to securely prevent the target workpiece from being exposed to light through the alignment.

In addition to the foregoing configuration, the alignment camera unit includes the illumination portion configured to illuminate the target workpiece with the non-exposure light. Thereby, the state of the target workpiece can be more securely and clearly recognized on the image captured by the image pickup device.

In addition to the foregoing configuration, the alignment lighting unit is provided to be capable of advancing onto and retracting from the irradiation optical path for casting the exposure light upon the mask, and the alignment camera unit is provided capable of advancing onto and retracting from the projection optical path for projecting the mask pattern on the target workpiece between the projection lens and the target workpiece. Thereby, the alignment can be performed simply and easily without hindering the operation of exposing the target workpiece to radiation.

What is claimed is:

1. An exposure apparatus which forms a predetermined mask pattern on a target workpiece through exposure by: casting exposure light upon a mask in which the pattern and a mask-side alignment mark are formed, and forming an image of the mask on the target workpiece by projecting the exposure light, which passes the mask, on the target workpiece through a projection lens, comprising:
an alignment lighting unit configured to cast, as alignment light, light in a wavelength range included in the exposure light onto the mask-side alignment mark of the mask; and
an alignment camera unit including an image pickup device for capturing images, and configured to receive the incident alignment light coming from the alignment lighting unit through the mask and the projection lens,
the alignment camera unit including:
an image formation optical system configured to form a mask-side alignment mark image by use of the incident alignment light in a dummy workpiece area located in a position which is different from the target workpiece and makes an optical positional relationship of the alignment light thereon with the mask equal to an optical positional relationship of the target workpiece with the mask; and
an image pickup optical system configured to make an optical positional relationship of the target workpiece with the image pickup device and an optical positional relationship of the dummy workpiece area with the image pickup device equal to each other.

2. The exposure apparatus according to claim 1, wherein
the image formation optical system comprises:
a dummy workpiece portion forming a flat surface in the dummy workpiece area; and
a reflection portion configured to cause the alignment light to travel toward the dummy workpiece portion, the alignment light coming from the alignment lighting unit through the mask and the projection light, and received by the alignment camera unit, wherein
the mask and the dummy workpiece portion are placed in an optically conjugate positional relationship on an optical path passing the projection lens and the reflection portion.

3. The exposure apparatus according to claim 2, wherein
the reflection portion is a half-mirror,
the image pickup optical system comprises the reflection portion, and an image formation lens provided on an optical path which extends from the target workpiece to the image pickup device via the reflection portion,
the dummy workpiece portion and the image pickup device are placed in an optically conjugate positional relationship on an optical path passing the reflection portion, and
the target workpiece and the image pickup device are placed in an optically conjugate positional relationship on the optical path via the reflection portion.

4. The exposure apparatus according to claim 1, wherein the alignment camera unit comprises an exposure light blocking portion configured to prevent the incident alignment light from reaching the target workpiece.

5. The exposure apparatus according to claim 1, wherein the alignment camera unit comprises an illumination portion configured to illuminate the target workpiece with non-exposure light.

6. The exposure apparatus according to claim 1, wherein
the alignment lighting unit is provided to be capable of advancing onto and retracting from an irradiation optical path for casting the exposure light upon the mask, and
the alignment camera unit is provided to be capable of advancing onto and retracting from a projection optical path for projecting the mask pattern on the target workpiece between the projection lens and the target workpiece.
